(19) United States
(12) Patent Application Publication
(10) Pub. No.: US 2007/0228689 A1
(43) Pub. Date: Oct. 4, 2007

(54) Bicycle frame tube structure for enhancing the rigidity of the bicycle frame

(76) Inventor: Chun-Hung Lin, Taichung City (TW)

Correspondence Address: CHUN-HUNG LIN, 235 CHUNG-HO, Box 8-24, Taipei, TW

(21) Appl. No.: 11/394,245

(22) Filed: Mar. 31, 2006

(51) Int. Cl. B62K 7/00

(52) U.S. Cl. 280/281.1

(57) ABSTRACT

A bicycle frame tube structure comprises a combining section; one end of the combining section having two opening for receiving a tube of a rear upper bi-forked tube; and a stand tube clamped between the two tubes. The combining section is two bi-forked tubes of an upper tube; or the combining section is a hollow U shape tube which have the two opening at one end; and another end of the U shape tube serves to be connected to an upper tube; or the combining section is a block which contains two tubes; or the combining section is a lower tube which has a bi-forked tube at one end; each tube of the bi-forked tube has the opening. The two bi-forked tubes of the upper tube may be combined as one tube for being connected to a head tube or the two tubes are directly connected to the head tube.

### FIELD OF THE INVENTION

The present invention relates to bicycles, and particularly to a bicycle frame tube structure for enhancing the rigidity of the bicycle frame, wherein the bicycle frame has an enhanced rigidity for suffering from a strong react force or a heavy load.

### BACKGROUND OF THE INVENTION

Other than suffering from the weight of the rider, a bicycle must suffer from the react force from the road if the road is not flat. The structure of the bicycle must provide sufficient rigidity.

To the rigidity of the bicycle frame, the connections of the tubes are necessary to be considered. Referring to FIG. 7, a prior art bicycle has a longitudinal head tube. An upper end and a lower end of the head tube are connected to an upper tube and a lower tube, respectively. A free end of the upper tube is welded to a longitudinal stand tube. The lower tube is connected to a five communicated tube at a lower end of the stand tube. A rear end of the stand tube is welded with a connecting tube for receiving a Y shape stub tube. A rear end of the stand tube are welded with a rear upper bi-forked tube and a rear lower bi-forked tube so as to form a bicycle frame.

In the prior art bicycle frame, the tubes are connected by welding. Most of the weight applied to the stand tube. However from the drawing, it is known that in the connection of the stand tube to the upper tube, the connection section of the upper tube is formed with a configuration corresponding to that of the stand tube so that an end portion of the upper tube can resist against and weld to the stand tube. However there is only one welding point which is insufficient to suffer from the react force of the path and the heavy weight applied to the bicycle frame. Thereby the stand tube is separated from the upper tube at the welding point. However this will generate dangerous condition in riding.

To overcome above mentioned defect, in U.S. Pat. No. 158,197, a T tube is connected to the stand tube. A combining section of the T shape tube is connected to an upper tube, and two tubes of an upper bi-forked tube are connecting to the connection sections of the T shape tube so as to provide a preferred combinational structure. However the two bi-forked sections of the T shape tube are inclined with respective to the stand tube. Thereby the connection between the upper bi-forked section and the T shape tube will be interfered by the stand tube. Furthermore, to have a safety connection strength between the combining section of the T shape tube and the connection section of the upper bi-forked tube, a predetermined connection length must be provided. However for a small bicycle, the connection length is unchangeable. As a result, the length of the rear upper bi-forked tube must be reduced and thus a small bicycle frame can not be installed successfully. Thus the structure is not suitable for a small bicycle frame.

In U.S. Pat. No. 5,129,666, a T shape tube of a stand tube is used to screw an upper tube and a combining section with a rear bi-forked section is screwed to a rear lower bi-forked tube. The prior art still has the problem that when the T shape tube provides a sufficient rigidity to the tube, it can not be used to a small bicycle frame.

Thus, there is a necessary for a now bicycle frame which can provide sufficient rigidity and is suitable for great and small bicycles.

### SUMMARY OF THE INVENTION

The present invention of the present invention is to provide a bicycle frame tube structure for enhancing the rigidity of the bicycle frame, wherein the bicycle frame has an enhanced rigidity for suffering from a strong react force or a heavy load.

To achieve above object, the present invention provides a bicycle frame tube structure for enhancing the rigidity of the bicycle frame comprising: a combining section; one end of the combining section having two opening for receiving a tube of a rear upper bi-forked tube; and a stand tube clamped between the two tubes. The combining section is two tubes; each tube has the opening at one end; another ends of the two tubes are connected to a head tube; or the combining section is an upper tube; one end of the upper tube is divided into two tubes; each tube has the opening at one end; another end of the combining section is combined as one tube for connecting with a head tube; or the combining section is a hollow U shape tube which have the two opening at one end; and another end of the hollow U shape tube serves to be connected to an upper tube; or the combining section is a block which contains two tubes; or the combining section is a lower tube which has a bi-forked two tubes at one end; each tube of the bi-forked two tubes has the opening.

The various objects and advantages of the present invention will be more readily understood from the following detailed description when read in conjunction with the appended drawing.

### BRIEF DESCRIPTION OF THE DRAWINGS

FIG. 1 is an exploded perspective view of the bicycle frame tube structure for enhancing the rigidity of the bicycle frame of the present invention.

FIG. 2 is a schematic perspective view of the bicycle frame tube structure for enhancing the rigidity of the bicycle frame of the present invention.

FIG. 3 is a schematic perspective view of the second embodiment of the bicycle frame tube structure for enhancing the rigidity of the bicycle frame according to the present invention.

FIG. 4 is a schematic perspective view of the third embodiment about the bicycle frame tube structure for enhancing the rigidity of the bicycle frame of the present invention.

FIG. 4A is a schematic view showing the hollow U shape tube in FIG. 4.

FIG. 5 is a schematic perspective view about the fourth embodiment of the bicycle frame tube structure for enhancing the rigidity of the bicycle frame of the present invention.

FIG. 5A is a partial schematic view about the connection of the block and the stand tube of FIG. 5.

FIG. 6 is a schematic perspective view about the fifth embodiment of the bicycle frame tube structure for enhancing the rigidity of the bicycle frame according to the present invention.

FIG. 7 is a schematic perspective view of a prior art bicycle.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

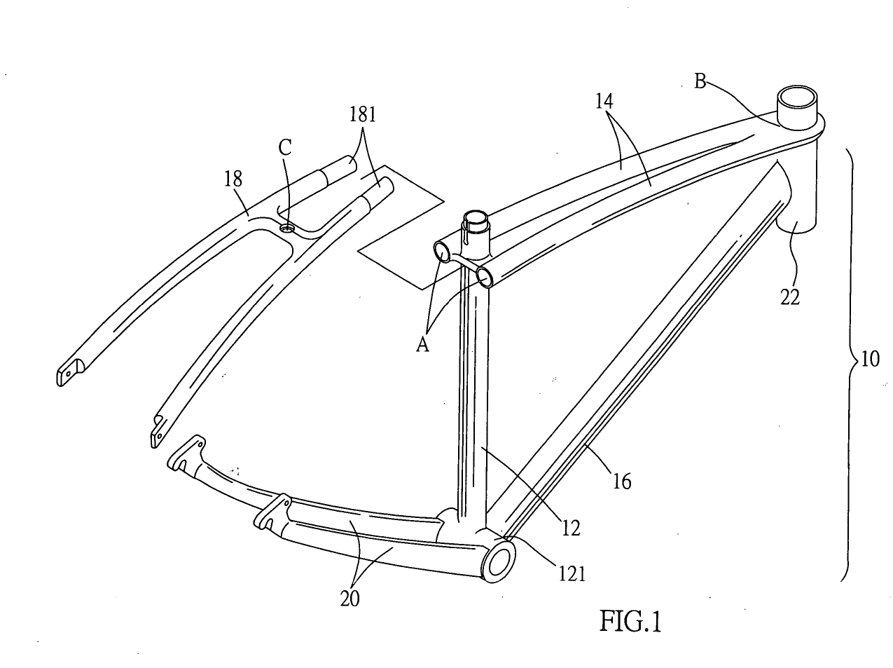

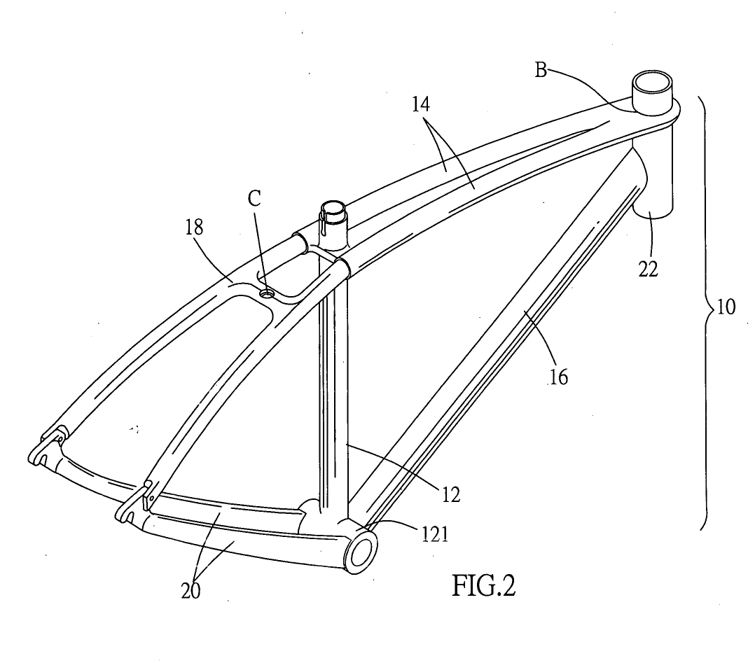

Referring to FIGS. 1, and 2, the present invention relates to a bicycle frame tube structure for enhancing the rigidity of the bicycle frame. In generally, the bicycle frame has the following elements. A stand tube 12 has a top. A front end of the stand tube 12 is combined with an upper tube 14 and a rear end thereof is combined with a rear upper bi-forked tube 18. A hollow U shape tube 30 is installed at a bottom end of the stand tube 12. A front end of the five communicated tube 121 has a lower tube 16 and a rear end thereof has a rear lower bi-forked tube 20. The upper tube 14 and lower tube 16 are connected to a hollow U shape tube 30 at ends far away from the five communicated tube 121.

Referring to FIGS. 1 and 2, one end of the upper tube 14 is a bi-forked end which has two stub tubes. The two stub tubes clamp the stand tube 12. Each end of the two stub tubes is formed with an engaging portion A for receiving a connecting section 181 at one of two front ends of the rear upper bi-forked tube 18. Another end of the upper tube 14 is formed as a combining portion B for combining the head tube 22. The rear upper bi-forked tube 18 is combined to the upper tube 14 along a tangent line direction of the upper tube 14.

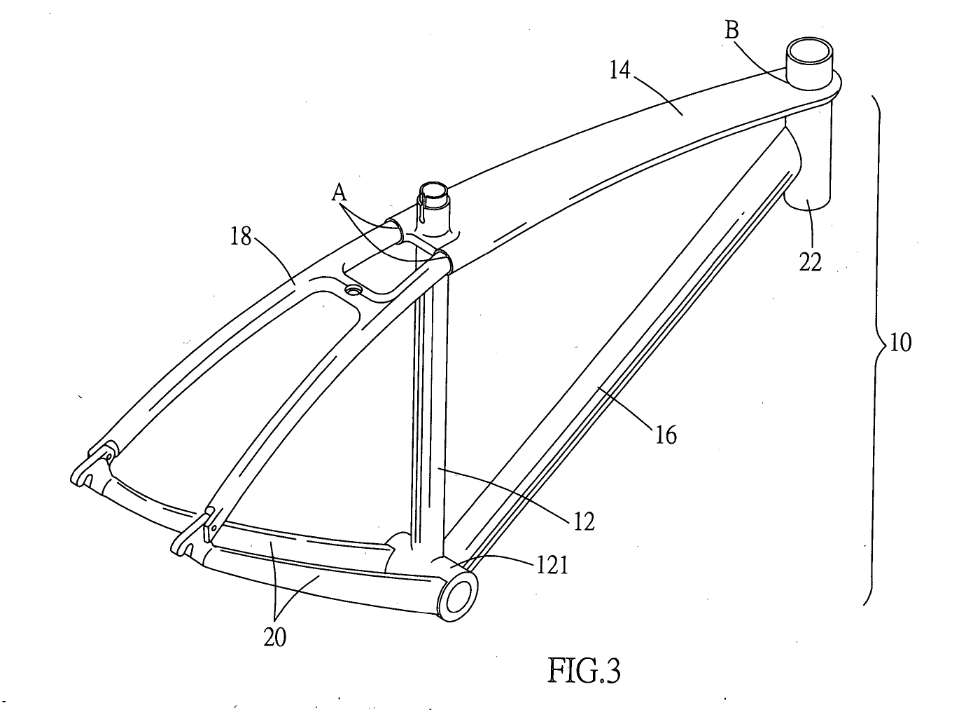

Referring to FIG. 3, in another embodiment, the upper tube 14 is a single hollow tube. One end is formed with a combining portion A which has two openings for receiving two connection section of the two front ends of the rear upper bi-forked tube 18. The stand tube 12 penetrates through the upper tube 14. The rear upper bi-forked tube 18 is combined to the upper tube 14 along a tangent line direction of the upper tube 14.

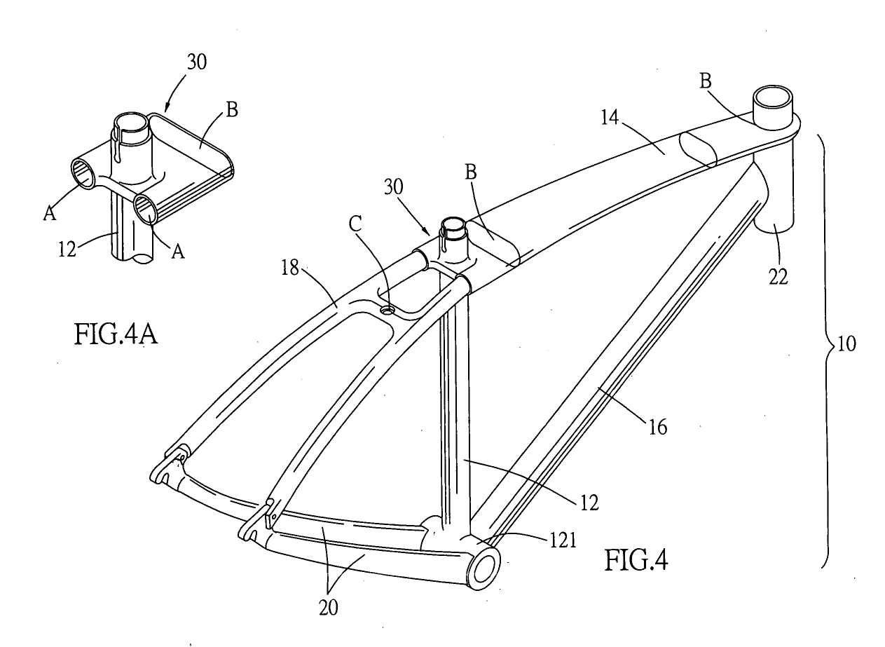

Referring to FIGS. 4 and 4A, a hollow U shape tube 30 is used to connect the upper tube 14 to the rear upper bi-forked tube 18. One end of the hollow U shape tube 30 has two leg tubes. Each leg tube is formed with an opening A for receiving one of two front ends of the rear upper bi-forked tube 18. Another end of the hollow U shape tube 30 is a hollow opening which is connected to the upper tube 14. The stand tube 12 is welded between the two leg tubes. The rear upper bi-forked tube 18 is combined to the upper tube 14 through the hollow U shape tube 30 and along a tangent line direction of the upper tube 14.

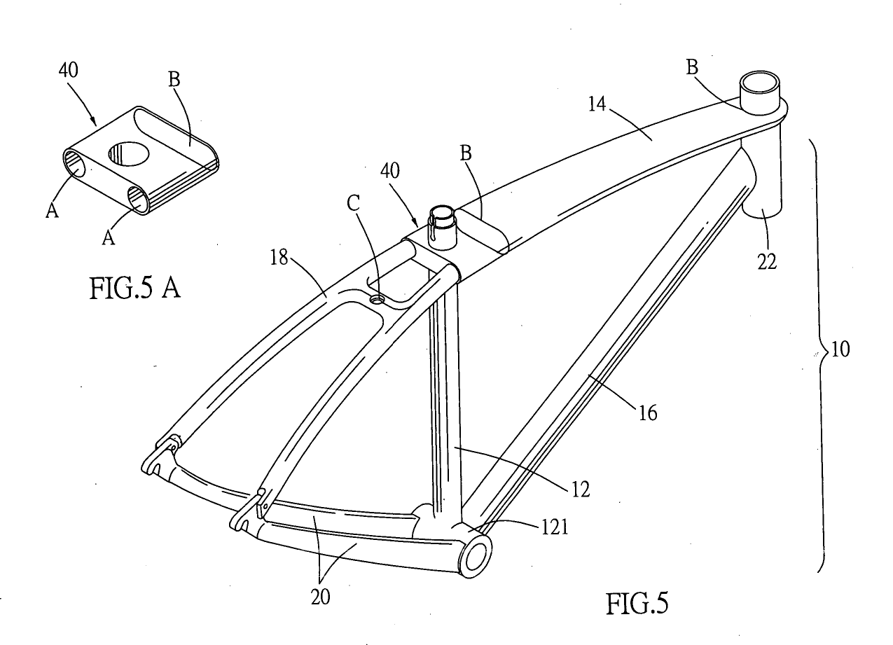

Referring to FIGS. 5 and 5A, in another embodiment of the present invention, the hollow U shape tube 30 in FIG. 4 is replaced by a hollow block 40. One end of the block 40 has one opening for receiving the upper tube 14 and another end of the block 40 is formed with two openings for receiving the two front ends of the rear upper bi-forked tube 18. The stand tube 12 penetrates through the middle portion of the block 40. The rear upper bi-forked tube 18 is combined to the upper tube 14 through the hollow block 40 and along a tangent line direction of the upper tube 14.

In all above mentioned structure, the stand tube 12 is welded to the upper tube 14 directly, or through the hollow U shape tube 30 or the hollow block 40. However the stand tube 12 is enclosed by the two legs of the upper tube 14, or enclosed by the hollow U shape tube 30 or the hollow block 40 so that the stand tube 12 is firmly secured to the upper tube 14. The connection of the rear upper bi-forked tube 18 to the upper tube 14 is higher than the connection of the stand tube 12. Furthermore, the length from the rear upper bi-forked tube 18 to the brake seat C is not limited by the connection length. Thus the small bicycle frame can be installed easily.

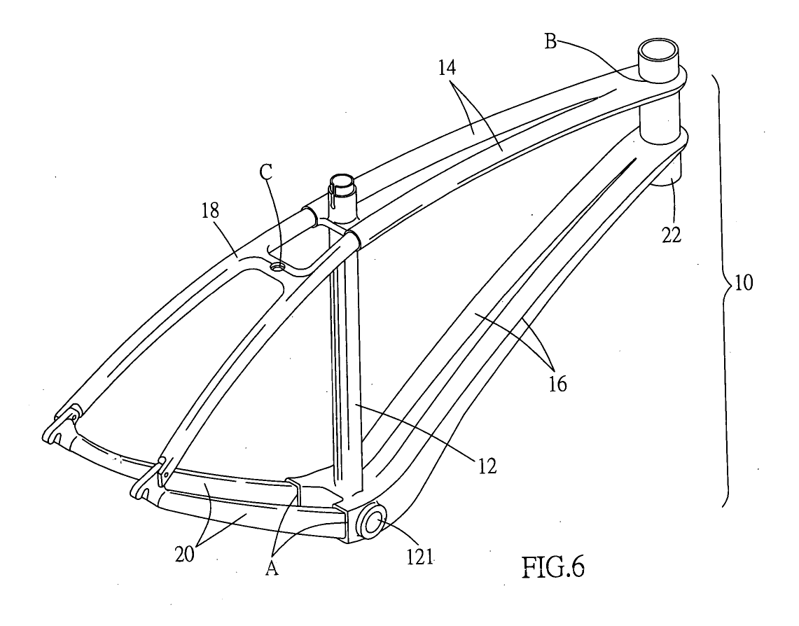

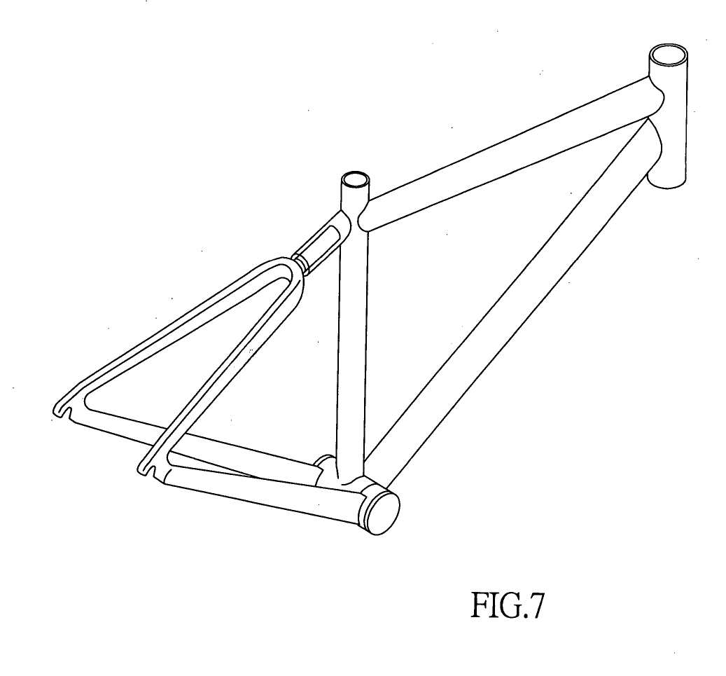

Above mentioned connection way for connecting the stand tube 12, upper tube 14, and the rear upper bi-forked tube 18 (as illustrated in FIGS. 1 to 5) can be used to the connection of the five communicated tube 121, lower tube 16 and the rear lower bi-forked tube 20 as illustrated in FIG. 6.

In summary, the combination of the tubes of the bicycle frame is performed by a hollow structure to clamp the stand tube at two sides. Thus the longitudinal tubes and transversal tubes of the bicycle frame have at least two welding points so as to provide sufficient rigidity. This technology can be used to a small bicycle frame which is not confined by the connection length. Thereby the structure of the bicycle can be retained in a safe and steady state.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle frame tube structure for enhancing the rigidity of the bicycle frame comprising:
a combining section; one end of the combining section having two opening for receiving a tube of a rear upper bi-forked tube;
a stand tube clamped between the two tubes.

2. The bicycle frame tube structure for enhancing the rigidity of the bicycle frame as claimed in claim 1, wherein the combining section is two tubes; each tube has the opening at one end; another ends of the two tubes are connected to a head tube.

3. The bicycle frame tube structure for enhancing the rigidity of the bicycle frame as claimed in claim 1, wherein the combining section is an upper tube; one end of the upper tube is divided into two tubes; each tube has the opening at one end; another end of the combining section is combined as one tube for connecting with a head tube.

4. The bicycle frame tube structure for enhancing the rigidity of the bicycle frame as claimed in claim 1, wherein the combining section is a hollow U shape tube which have the two opening at one end; and another end of the hollow U shape tube serves to be connected to an upper tube.

5. The bicycle frame tube structure for enhancing the rigidity of the bicycle frame as claimed in claim 1, wherein the combining section is a block which contains two tubes.

6. The bicycle frame tube structure for enhancing the rigidity of the bicycle frame as claimed in claim 1, wherein the combining section is a lower tube which has bi-forked two tubes at one end; each tube of the bi-forked two tubes has the opening.
